(19) United States
(12) Patent Application Publication
(10) Pub. No.: US 2003/0066362 A1
(43) Pub. Date: Apr. 10, 2003

(54) Seat belt tension sensor

(76) Inventors: Shih Yuan Lee, Canton, MI (US); James G. Stanley, Novi, MI (US)

Correspondence Address: DINNIN & DUNN, P.C., 2701 CAMBRIDGE COURT, SUITE 500, AUBURN HILLS, MI, 48326, US

(21) Appl. No.: 10/229,431

(22) Filed: Aug. 27, 2002

Related U.S. Application Data
(60) Provisional application No. 60/315,822, filed on Aug. 29, 2001.

(51) Int. Cl. G01L 1/26

(52) U.S. Cl. 73/862.391

(57) ABSTRACT

An apparatus for measuring a tensile load in a flexible element comprises a housing, a guide surface either operatively coupled to or a part of the housing, a deflector comprising a spring operatively coupled to the housing, and a sensor operatively coupled to the housing. The guide surface is adapted to support the flexible element at a first location so as to substantially prevent transverse displacement of the flexible element in a first direction relative to the housing. The deflector and the sensor are adapted to operatively engage the flexible element at a second location and a third location respectively, or vice versa, wherein the third location is between the first location and the second location. The operative engagement of the sensor with the flexible element acts to resist transverse displacement thereof in the first direction. The guide surface, the deflector and the sensor are arranged so that the third location is displaced by a relative displacement in the first direction. A deflection of the deflector is responsive to the tensile load along the flexible element, the relative displacement is responsive to the deflection of the deflector, and the sensor is responsive to a component of force from the flexible element in the first direction.

### CROSS-REFERENCE TO RELATED APPLICATIONS

The instant application claims the benefit of prior U.S. Provisional Application Serial No. 60/315,822 filed on Aug. 27, 2001, which is incorporated herein by reference.

### BRIEF DESCRIPTION OF THE DRAWINGS

In the accompanying drawings:

FIG. 1 illustrates a top-view of an occupant in a vehicle seat wearing a seat belt, wherein the seat belt incorporates a seat belt tension sensor;

FIG. 2 illustrates a front-view of a vehicle seat upon which a child seat is secured by a seat belt, wherein the seat belt incorporates a seat belt tension sensor and the vehicle seat incorporates a seat weight sensor;

FIG. 3 illustrates scenarios associated with various seat belt tensile load ranges;

FIG. 4a illustrates a schematic diagram of a first aspect of an apparatus for measuring a tensile load in a flexible element;

FIG. 4b illustrates a schematic diagram of a second aspect of an apparatus for measuring a tensile load in a flexible element;

FIG. 5 illustrates a geometry and the associated forces of the first aspect of an apparatus for measuring a tensile load in a flexible element illustrated in FIG. 4a;

FIG. 6a illustrates a sensor response characteristic plotted with linear scales, for a first aspect of an apparatus for measuring a tensile load in a flexible element;

FIG. 6b illustrates a sensor response characteristic plotted with logarithmic scales, for a first aspect of an apparatus for measuring a tensile load in a flexible element;

FIG. 7 illustrates a normalized transverse deflection of a deflector as a function of tensile load, for a first aspect of an apparatus for measuring a tensile load in a flexible element;

FIG. 8 illustrates a cross-sectional side-view of one embodiment of a seat belt tension sensor;

FIG. 9 illustrates a side-view of a sensor substrate assembly of a seat belt tension sensor in accordance with FIG. 8;

FIG. 10 illustrates a bottom-view of a sensor substrate assembly of a seat belt tension sensor in accordance with FIG. 8;

FIG. 11 illustrates one embodiment of an electronic circuit of a seat belt tension sensor;

FIG. 12 illustrates another embodiment of an electronic circuit of a seat belt tension sensor; and

FIG. 13 illustrates a top-view of a deflector assembly of a seat belt tension sensor in accordance with FIG. 8.

### DETAILED DESCRIPTION

There exists a need for measuring a tensile load in a flexible load bearing element, such as a webbing, cable, rope or thread. As an example, there exists a need to measure a tensile load in a seat belt used in vehicular safety restraint system, wherein the seat belt load measurement can be used to distinguish a type of object secured by the seat belt, or can be used to compensate for the affect of seat belt loads upon a measurement of seat weight from a seat weight sensor in the seat base.

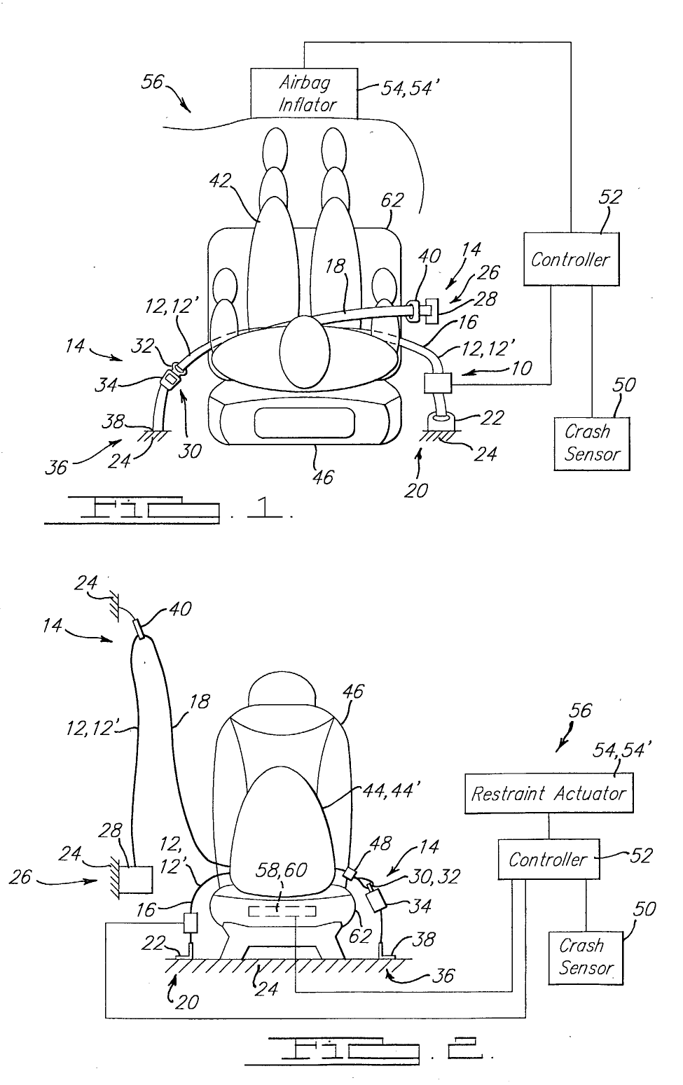

Referring to FIG. 1, a seat belt tension sensor 10 is operatively coupled to a webbing 12 of a seat belt 14, for measuring a tensile load therein. Generally, the webbing 12 constitutes a flexible element 12′ capable of supporting a tensile load, but typically—i.e. for practical lengths, wherein the tensile load is applied along the length of the flexible element—is incapable of supporting more than an insubstantial compressive load without buckling.

The seat belt 14 illustrated in FIG. 1—generally known as a “three-point” seat belt with a continuous loop lap/shoulder belt—comprises a lap belt portion 16 and a shoulder belt portion 18, wherein one end of the lap belt portion 16 the seat belt 14 is attached at a “first point” 20 to a first anchor 22 secured to the vehicle frame 24, one end of the shoulder belt portion 18 is attached at a “second point” 26 to a seat belt retractor 28 secured to the vehicle frame 24, and the other ends of the lap belt portion 16 the shoulder belt portion 18 are located where the seat belt 14 passes through a loop 30 in a latch plate 32 that engages with a buckle 34 that is attached at a “third point” 36 to a second anchor 38 secured to the vehicle frame 24. The shoulder belt portion 18 passes through a “D-ring” 40 operatively connected to the vehicle frame 24 that guides the shoulder belt portion 18 over a shoulder of the occupant 42.

The seat belt retractor 28 has a spool that either provides or retracts webbing 12 as necessary to enable the seat belt 14 to placed around the occupant 42 sufficient to engage the latch plate 32 with the buckle 34, and to remove excess slack from the webbing 12. The seat belt retractor 28 provides a nominal tension in the seat belt 14 so that, responsive to a crash that causes the seat belt retractor 28 to lock the webbing 12 thereby preventing further withdrawal, the occupant 42 is restrained by the seat belt 14 relatively earlier in the crash event than would occur had there been slack in the seat belt 14. During the crash event, when restraining the occupant 42, the webbing 12 of the seat belt 14 can be exposed to a relatively high tensile load, the magnitude of which depends upon the severity of the crash and the mass of the occupant 42.

Referring to FIG. 2, the lap belt portion 16 of a seat belt 14 may also be used to secure a child seat 44, such as a rear facing infant seat 44′, to the vehicle seat 46, wherein a locking clip 48 may be used to prevent the shoulder belt portion 18 from sliding relative to the lap belt portion 16 proximate to the latch plate 32. In this case, the lap belt portion 16 is typically secured relatively tight—with an associated tensile load greater than the associated comfort limit for an adult—so as to hold the child seat 44 firmly in the vehicle seat 46 by compressing the seat cushion thereof, and the shoulder belt portion 18 is not otherwise relied upon for restraint.

Accordingly, the tensile load in the webbing 12 of the seat belt 14 can be used to discriminate an object on the vehicle seat 46, wherein a tensile load greater than a threshold would be indicative of a child seat 44. Referring to FIGS. 1 and 2, a seat belt tension sensor 10 is operatively coupled to a lap belt portion 16 of a webbing 12 of a seat belt 14 at a particular seating location. The seat belt tension sensor 10 and a crash sensor 50 are operatively coupled to a controller 52 that is adapted to control the actuation of a restraint actuator 54—e.g., an air bag inflator 54′—of a safety restraint system 56 located so as to protect an occupant at the particular seating location. If the tensile load sensed by the seat belt tension sensor 10 is greater than a threshold, then the restraint actuator 54 is disabled by the controller 52 regardless of whether or not a crash is detected by the crash sensor 50. If the tensile load sensed by the seat belt tension sensor 10 is less than a threshold, then the restraint actuator 54 is enabled by the controller 52 so that the restraint actuator 54 can be actuated responsive to a crash detected by the crash sensor 50. Alternately, for a controllable restraint actuator 54, e.g. a multi-stage air bag inflator 54′, the timing and number of inflator stages inflated can be controlled to effect a reduced inflation rate rather than disabling the air bag inflator 54′ responsive to the seat belt tension sensor 10 sensing a tensile load greater than a threshold.

Referring to FIG. 2, a seat belt tension sensor 10 may be used in conjunction with at least one other occupant sensor 58, e.g. a seat weight sensor 60, to control the actuation of a safety restraint system 56. The seat weight sensor 60 may operate in accordance with any of a variety of known technologies or embodiments, e.g. incorporating a hydrostatic load sensor, a force sensitive resistor, a magnetostrictive sensing elements, or a strain gage load sensor, which, for example, either measure at least a portion of the load within the seat cushion 62, or measure the total weight of the seat. In either case, a tensile load in the seat belt 14 that is reacted by the vehicle frame 24 acts to increase the load upon the seat cushion 62, thereby increasing the apparent load sensed by the seat weight sensor 60. The apparent load is increased by each reaction force, so that a given tensile load in the seat belt 14 could increase the apparent load sensed by the seat weight sensor 60 by as much as twice the magnitude of the tensile load. Accordingly, in a system with both a seat belt tension sensor 10 and a seat weight sensor 60, the seat weight measurement from the seat weight sensor 60 can be compensated for the effect of tensile load in the seat belt 14 so as to provide a more accurate measure of occupant weight, by subtracting, from the seat weight measurement, a component of seat weight caused by, or estimated to have been caused by, the tensile load measured by the seat belt tension sensor 10. If the seat weight measurement from the seat weight sensor 60 is not compensated for the effect of the tensile load in the seat belt 14, a child seat 44 secured to a vehicle seat 46 with a seat belt 14 could cause a load on the seat weight sensor 60 that is sufficiently high to approximate that of a small adult, so that an uncompensated seat weight measurement might cause the associated restraint actuator 54 to be erroneously enabled in a system for which the restraint actuator 54 should be disabled when a child seat 44 is on the vehicle seat 46.

In a system that compensates for the affect of seat belt tension on an occupant sensor 58, the seat belt tension sensor 10, the occupant sensor 58,—e.g. a seat weight sensor 60,—and a crash sensor 50 are operatively coupled to a controller 52 that is adapted to control the actuation of a restraint actuator 54—e.g., an air bag inflator 54′—of a safety restraint system 56 located so as to protect an occupant at the particular seating location. If the tensile load sensed by the seat belt tension sensor 10 is greater than a threshold, then the restraint actuator 54 is disabled by the controller 52 regardless of whether or not a crash is detected by the crash sensor 50 or regardless of the measurement from the occupant sensor 58. If the tensile load sensed by the scat belt tension sensor 10 is less than a threshold, then the restraint actuator 54 is enabled or disabled by the controller 52 responsive to a measurement from the occupant sensor 58, which may be compensated responsive to the tensile load sensed by the seat belt tension sensor 10. If the restraint actuator 54 is enabled, then the restraint actuator 54 can be actuated responsive to a crash detected by the crash sensor 50. Alternately, for a controllable restraint actuator 54, e.g. a multi-stage air bag inflator 54′, the timing and number of inflator stages inflated can be controlled to effect a reduced inflation rate rather than disabling the air bag inflator 54′ responsive to measurements from the occupant sensor 58 and the seat belt tension sensor 10.

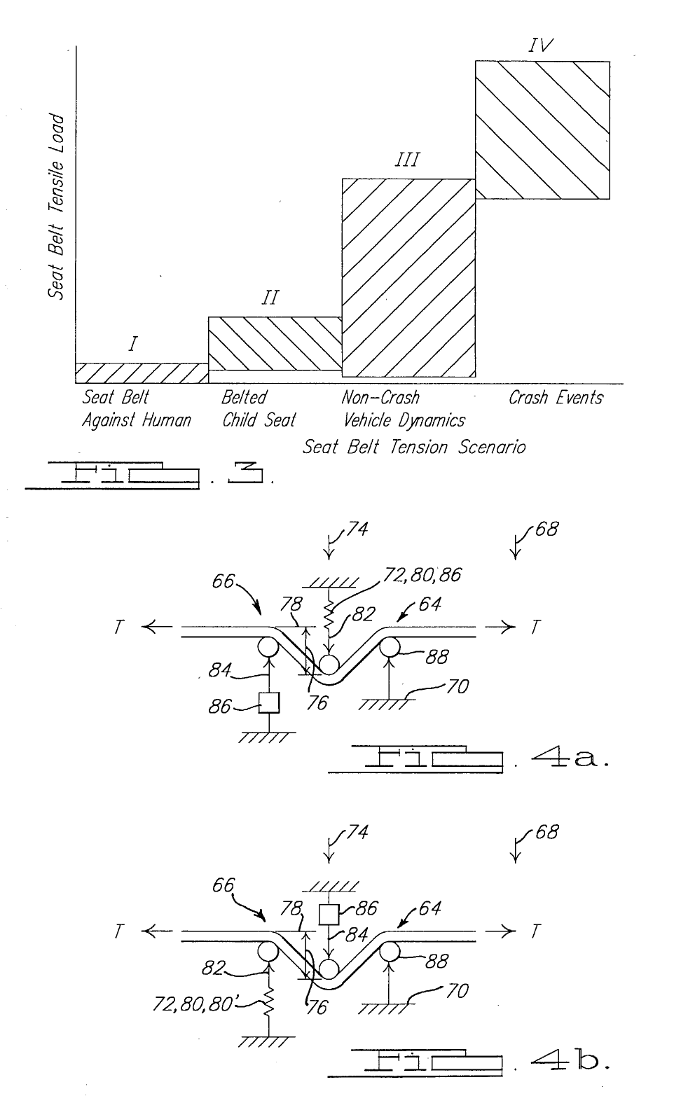

Referring to FIG. 3, the loads to which a seat belt 14 is normally exposed can be classified into four ranges as follows: 1) a low range (I) comprising tensile loads associated with the seat belt 14 being placed directly around a human, 2) a low-intermediate range (II) comprising tensile loads associated with the restraint a child seat 44, 3) a high-intermediate range (III) comprising loads associated with non-crash vehicle dynamics, e.g. braking or rough roads, and 4) a high range (IV) comprising tensile loads associated with restraint forces of a crash event. The low range (I), for example, would normally be limited by the maximum tensile load that an occupant 42 could comfortably withstand. The low-intermediate range (II), for example, would normally be limited by the maximum tensile load that a person could apply to the seat belt 14 while securing a child seat 44 to the vehicle seat 46. Notwithstanding that the seat belt 14 and associated load bearing components can be subject to the high range (IV) tensile loads, a seat belt tension sensor 10 would be useful for controlling a safety restraint system 56 if it were capable of measuring low-intermediate range (II) tensile loads associated with securing a child seat 44 to a vehicle seat 46.

Referring to FIG. 4a, in accordance with a first aspect of an apparatus for measuring a tensile load T in a flexible element 12′—e.g. a seat belt tension sensor 10 for measuring a tensile load T in a webbing 12 of a seat belt 14—the flexible element 12′ is supported at first 64 and second 66 locations so as to resist transverse displacements thereof in a first direction 68 thereat, wherein the relative transverse displacements at the first 64 and second 66 locations are relative to a datum 70. The flexible element 12′ is transversely displaced in the first direction 68 by a deflector 72 at a third location 74 between the first 64 and second 66 locations, wherein a relative transverse displacement 76 of the flexible element 12′ at the third location 74 in the first direction 68 relative to a line 78 between the first location 64 and the second location 66 is responsive to a tensile load T in the flexible element 12′ when the tensile load T is applied to the flexible element 12′ so as to be directed along the flexible element 12′. The deflector 72 comprises at least one compliant element 80, e.g. at least one spring 80′. The deflector 72 applies a first force 82 having a vector component in the first direction 68 to the flexible element 12′, wherein the first force 82 is responsive to the relative transverse displacement 76 of the flexible element 12′. A second force 84 having a vector component 85 in the first direction 68 is measured at the second location 66 by a sensor 86, wherein the second force 84 is responsive to the tensile load T in the flexible element 12′. The sensor 86 transversely supports the flexible element 12′ at the second location 66 so as to resist relative transverse displacement 76 thereof in the first direction 68. The flexible element 12′ may be supported at the first location 64, for example, by a guide surface 88 that is substantially rigid relative to the datum 70.

In operation, with no tensile load T applied to the flexible element 12′, the deflector 72 is maximally extended so as cause a maximal relative transverse displacement 76 of the flexible element 12′, and the second force 84 applied by the flexible element 12′ to the sensor 86 is insubstantial. As the tensile load T is increased, the flexible element 12′ deflects the deflector 72, thereby increasing the magnitude of the first force 82 which in turn increases the magnitude of the second force 84 that is sensed by the sensor 86. The magnitudes of the first 82 and second 84 forces approach respective limits as the tensile load T is increased, which causes the flexible element 12′ to approach a shape that is straight between the first 64 and second 66 locations. Neither the deflector 72 nor the sensor 86 are in series with the load path of the tensile load T in the flexible element 12′. Accordingly, the process by which the seat belt 14 bears the tensile load T does not depend on the process by which the tensile load T is measured. Since neither the deflector 72 nor the sensor 86 directly bear the tensile load T, the elements thereof can be made smaller, lighter and cheaper than would otherwise be required. For example, the compliance of the deflector 72 may be adapted so that the first 82 and second 86 forces—respectively acting on the deflector 72 and sensor 86—are substantially smaller that the magnitude of the associated tensile load T in the flexible element 12′.

Referring to FIG. 4b, a second aspect of an apparatus for measuring a tensile load T in a flexible element 12′ is similar to the first aspect described hereinabove, except that the locations of the deflector 72 and the sensor 86 are interchanged.

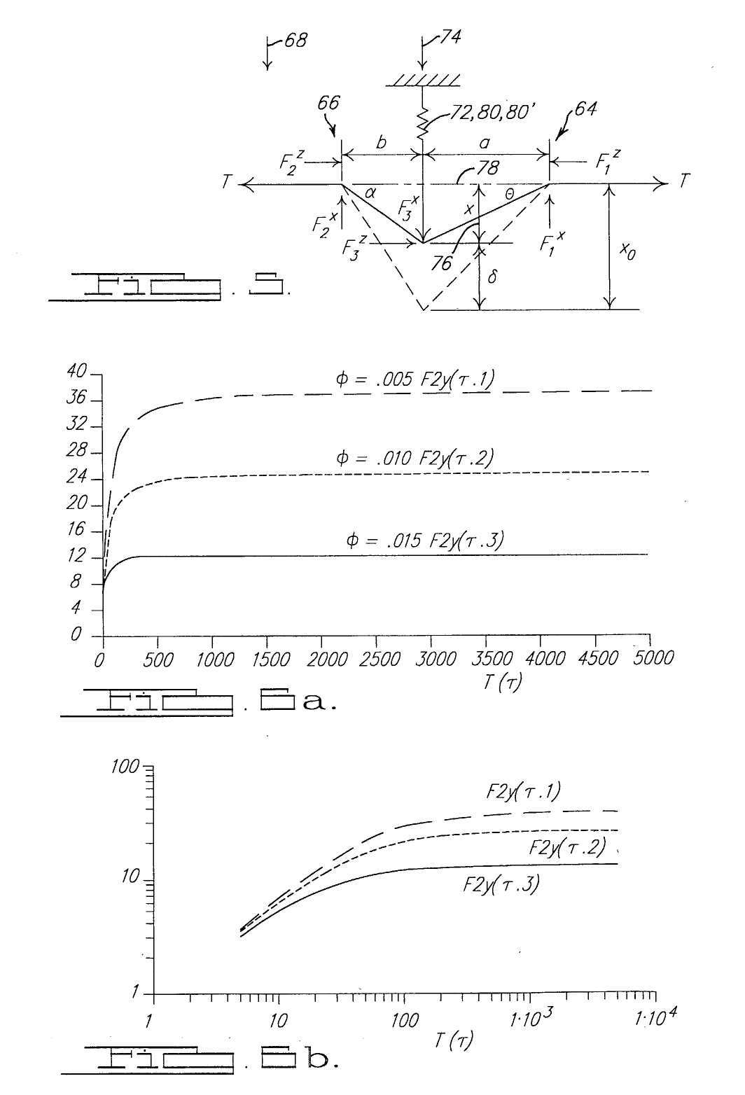

Referring to FIG. 5, the flexible element 12′ is respectively supported at first 64 and second 66 locations at distances a and b respectively from third location 74 of a deflector 72 that, in an unloaded condition, transversely deflects the flexible element 12′ by a distance x₀, wherein the transverse direction is taken to be normal to a line 78 intersecting the first 64 and second 66 locations For purposes of analysis, the distances a and b are related to the distance x₀ as follows:

a=β·x₀ (1)

b=γ·a (2)

A tensile load T applied to the flexible element 12′ causes the deflector 72 to deflect by a distance δ, thereby applying a transverse force F₃^{x} to the flexible element 12′ at the third location 74, wherein for a deflector comprising a spring 80′ having an effective spring constant K, the associated spring force F₃^{x} is given by:

F₃^{x}=K·δ (3)

The transverse deflection x of the flexible element 12′ at the third location 74 is responsive to the tensile load T in the flexible element 12′. The transverse deflection x results in associated deflection angles θ and α of the flexible element 12′ at the first 64 and second 66 locations respectively. A balance of forces at the third location 74 gives:

$$sin ( θ ) + sin ( α ) = \frac{K \cdot δ}{T} \qquad ( 4 )$$

The spring constant K is assumed for purposes of analysis and illustration to be linear. If a maximum tensile load T in the flexible element 12′ of Tₘₐₓ were hypothetically applied across the spring 80′, the associated spring deflection would be xₘₐₓ, and the spring constant K can be expressed as the ratio:

$$K = \frac{{T}_{max}}{{x}_{max}} \qquad ( 5 )$$

The normalized transverse deflection r is given by the ratio:

$$r = \frac{x}{{x}_{0}} \qquad ( 6 )$$

The deflection δ of the deflector 72 is then given by:

δ=(1−r)·x₀ (7)

If the flexible element 12′ was stretched straight between the first 64 and second 66 locations, the spring 80′ would be deflected by a deflection of δ=x₀, resulting in a maximum transverse force of F₃_{_{—}}ₘₐₓ. The normalized maximum transverse force φ, defined as the ratio of this maximum transverse force F₃_{_{—}}ₘₐₓ to the maximum tensile load Tₘₐₓ, is given by:

$$φ = \frac{{x}_{0}}{{x}_{max}} = \frac{{F}_{3 \_max}}{{T}_{max}} \qquad ( 8 )$$

The normalized tensile load τ, defined as the ratio of the tensile load T to the maximum tensile load Tₘₐₓ, is given by:

$$τ = \frac{T}{{T}_{max}} \qquad ( 9 )$$

Substituting equations (5) through (9) into equation (4) then gives:

$$\frac{r}{1 - r} \cdot ( \frac{1}{\sqrt{{β}^{2} + {r}^{2}}} + \frac{1}{\sqrt{{( γ \cdot β )}^{2} + {r}^{2}}} ) = \frac{φ}{T} \qquad ( 10 )$$

Setting γ=1 (i.e. a=b) and β=1 (i.e. a=x₀) for purposes of analysis and illustration, this can be solved analytically for the normalized transverse deflection r as a function of the normalized tensile load τ and the normalized maximum transverse force φ as follows:

$$r = \frac{1}{2} \cdot ( 1 + Q - \sqrt{{Q}^{2} + 2 Q - 3} ) \qquad ( 13 )$$

where:

$$\begin{matrix}P = {( \frac{τ}{φ} )}^{2} & ( 11 ) \\ Q = \sqrt{1 + 4 \cdot P} & ( 12 )\end{matrix}$$

The transverse force F₂^{x} at the second location 66 (i.e. sensed by the sensor 86) is then given as a function of the normalized tensile load τ and the normalized transverse deflection r as:

$${F}_{2}^{x} = T \cdot sin ( α ) = τ \cdot {T}_{max} \cdot \frac{r}{\sqrt{1 + {r}^{2}}} \qquad ( 14 )$$

The transverse force F₃^{x} at the third location 74 (i.e. caused by the deflector 72) is then given as a function of the maximum tensile load Tₘₐₓ, the normalized maximum transverse force φ, and the normalized transverse deflection r as:

F₃^{x}=K·δ=Tₘₐₓ·φ·(1−r) (15)

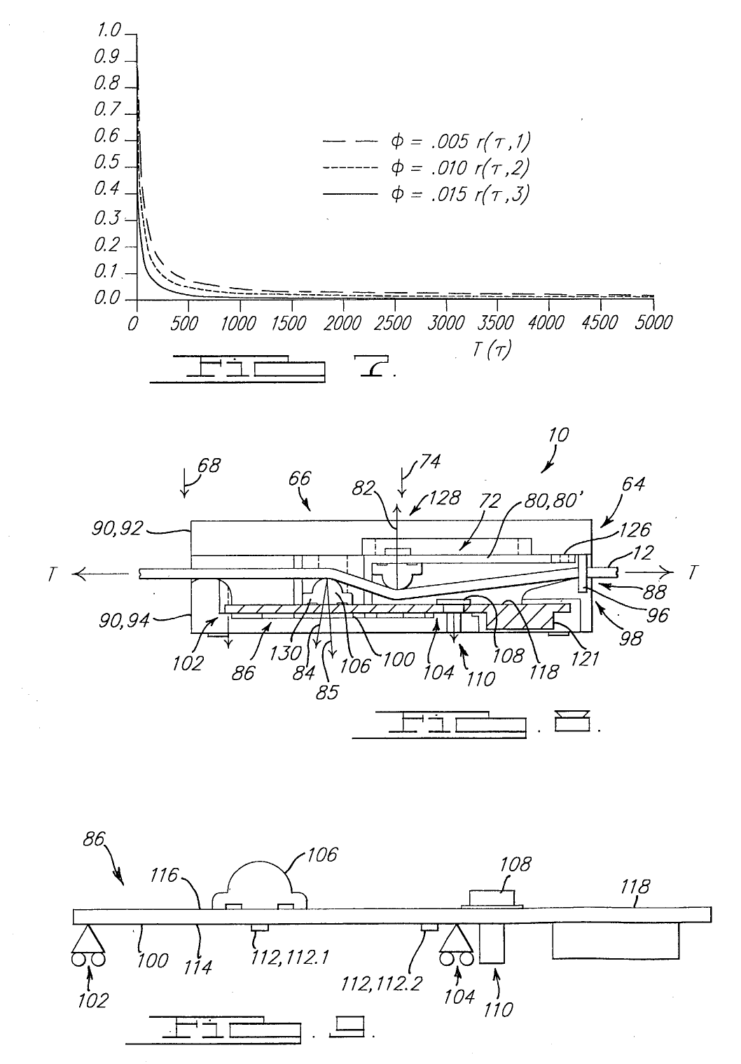

Referring to FIGS. 6a and 6b, the transverse force F₂^{x} at the second location 66 is plotted (using linear and logarithmic scales respectively) as a function of tensile load T for various levels of normalized maximum transverse force φ. The transverse force F₂^{x} exhibits significant variation with respect to tensile load T for relatively low levels of tensile load T, and is relatively insensitive to tensile load T for moderate to high levels of tensile load T. Accordingly, measurements of transverse force F₂^{x} can be used to infer tensile load T of the flexible element 12′ for relatively low tensile loads T using, for example, a curve fit (e.g. linear fit or piecewise linear fit) of the transverse force F₂^{x} vs. tensile load T relationship or a table lookup based upon direct or transformed (e.g. logarithmic transform as illustrated in FIG. 6b) measurements of transverse force F₂^{x}. FIGS. 6a and 6b also illustrate that range of tensile loads T over which the transverse force F₂^{x} is sensitive to tensile load T increases with increasing normalized maximum transverse force φ.

Referring to FIG. 7, a substantial range of normalized transverse deflection r of the deflector 72 corresponds to a relatively low range of tensile loads T, which also corresponds to the above described range of tensile loads T over which the transverse force F₂^{x} is sensitive to tensile load T. Moreover, the “sharpness” of the “knee” of this characteristic increases with decreasing normalized maximum transverse force φ.

Referring to FIG. 8, a seat belt tension sensor 10 in accordance with the first aspect of an apparatus for measuring a tensile load T in a flexible element 12′ comprises a housing 90; a guide surface 88 either operatively coupled to or a part of the housing 90; a deflector 72 comprising a spring 80′ operatively coupled to the housing 90; and a sensor 86.

The housing 90 comprises first 92 and second 94 housing portions that are secured to one another by, for example, one or more fasteners, bonding, staking or welding so as to resist separation responsive to internal forces that act thereupon during the operation of the seat belt tension sensor 10. The housing 90 may be adapted to engage the webbing 12 at a location so as to restrain translation of the housing 90 along the webbing 12. For example, the first housing portion 92 may incorporate a pin 96, operatively connected to the first housing portion 92 proximate to the first location 64, that pierces the webbing 12 and engages with a corresponding hole 98 in the second housing portion 94.

The guide surface 88 is adapted to support the webbing 12 of a seat belt 14 at a first location 64 so as to substantially prevent transverse displacement thereof in a first direction 68 relative to the housing 90 at the first location 64. For example, the guide surface 88 may be integrally formed as part of the second housing portion 94 as illustrated in FIG. 8. The sensor 86 is responsive to a component of force from the webbing 12 in the first direction 68

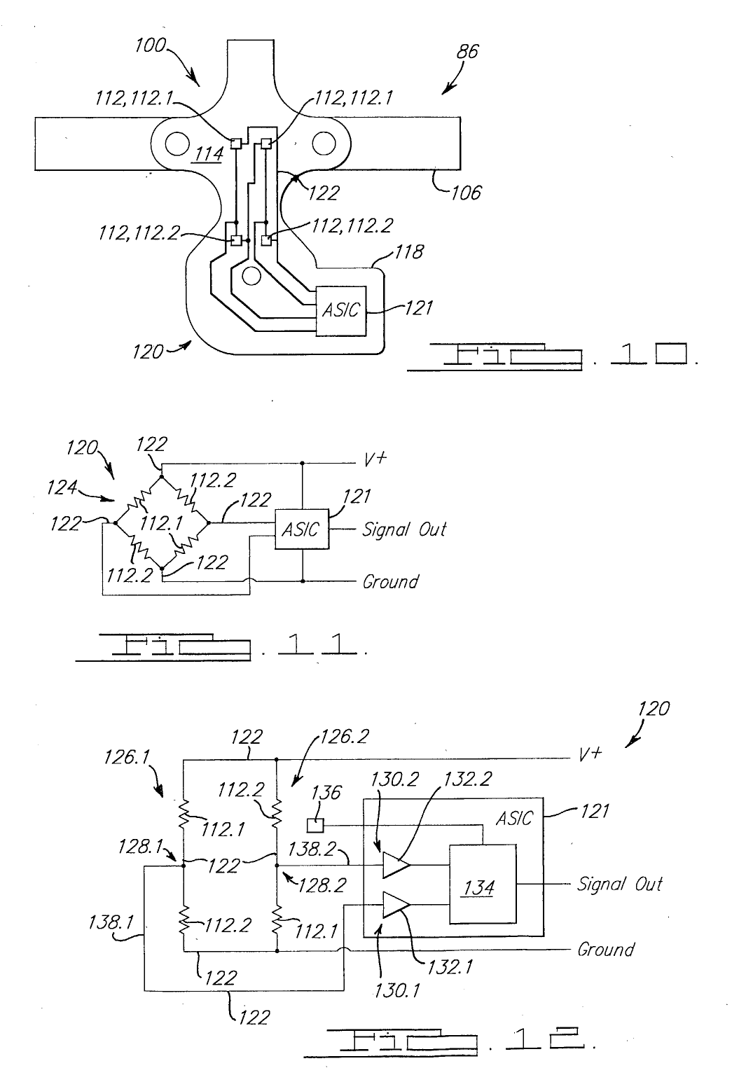

The sensor 86 is operatively coupled to the housing 90 and is adapted to operatively engage the webbing 12 at a second location 66. The operative engagement of the sensor 86 with the webbing 12 acts to resist transverse displacement thereof in the first direction 68. The sensor 86 is responsive to a component of force F₂^{x} from the webbing 12 in the first direction 68. Referring also to FIG. 9, the sensor 86 comprises a beam 100 supported by the second housing portion 94 at first 102 and second 104 support locations, with load distributor 106 operatively coupled to the beam 100 at a location therebetween that transfers a load from the webbing 12 to the beam 100 and acts to support the webbing 12 at the second location 66. For example, the load distributor 106 may be substantially centered between the first 102 and second 104 support locations. The beam 100 is transversely free at the first 102 and second 104 support locations, but is located and secured—for example, by a fastener 108—on the second housing portion 94 at a location 110 beyond the region between the first 102 and second 104 support locations. Alternately, the beam 100 could be cantilevered, with the load distributor 106 operatively coupled to the free end.

The sensor 86 further comprises at least one strain gage 112 on the beam 100 at a location that is subject to either tension or compression when the beam 100 is loaded by a load from the load distributor 106. As illustrated in FIGS. 9 and 10, the at least one strain gage 112 may be located on a surface 114 of the beam 100 opposite to a surface 116 upon to which the load distributor 106 is operatively coupled, so as to isolate the at least one strain gage 112 from direct contact with the webbing 12. The at least one strain gage 112 may be constructed in accordance with any known strain gage technology, for example a cermet strain gage, a silicon strain gage, or a foil strain gage, wherein strain gages having higher associated gage factors are beneficial in providing higher signal to noise ratio. For example, a foil strain gage typically has a gage factor of about 2, whereas a cermet strain gage may have a gage factor of up to 20. Cermet strain gages are beneficial because they can be formed by printing or screening the associated thick-film resistive elements.

Referring also to FIG. 10, the beam 100 is part of a substrate 118. For example, a substrate 118 made of type 430 stainless steel is compatible with cermet strain gage technology, wherein the strain gage is at least one strain gage 112 is formed by printing or screening a plurality of layers of various associated cermet materials on the substrate 118, one layer at a time, and then “firing” the substrate at an elevated temperature after each layer is printed or screened. The first layer comprises a dielectric. The second layer comprises the associated resistive element of the at least one strain gage 112, which, for example, may comprise ruthenium dioxide that, depending upon the associated grain size, provides a gage factor of about 6. The second layer also comprises associated conductive traces, e.g. dielectric conductors, of an electronic circuit 120. A third layer then comprises an overglaze. The substrate 118, although initially non-heat-treated, may become affected as a result of the firing processes.

The substrate 118 can be made sufficiently large to accommodate an electronic circuit 120 operatively connected to the at least one strain gage 112, and operatively connected to a surface 114 of an extension of the beam 100, i.e. on the substrate 118, wherein the surface 114 is opposite to the surface 116 upon to which the load distributor 106 is operatively coupled, so as to isolate the electronic circuit 120 from direct contact with the webbing 12. For example, the electronic circuit 120 may be packaged as a single element for improved reliability, for example, as an application specific integrated circuit (ASIC) 121.

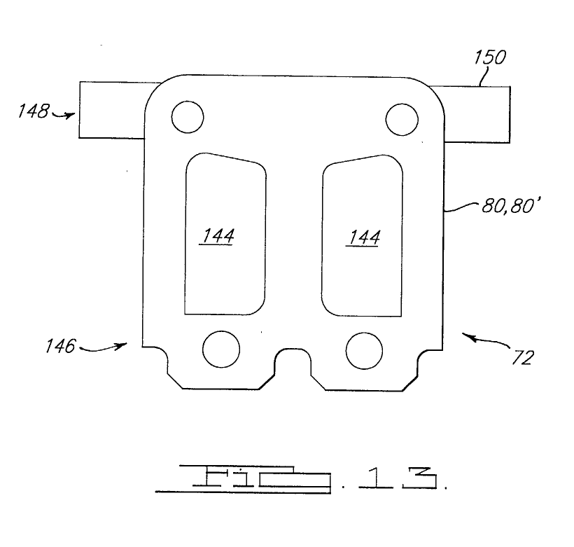

Referring to FIG. 10, a plurality of strain gages 112 are mounted on a common surface 114 of the beam 100, so as to facilitate interconnection thereof with circuit paths 122 without thru-holes. The common surface 114 of the beam 100 is opposite to the surface 116 upon to which the load distributor 106 is operatively coupled, so as to isolate the plurality of strain gages 112 from direct contact with the webbing 12. The plurality of strain gages 112 may be located so that at least one strain gage 112.1 is stressed in tension by loading from the load distributor 106, and at least one other strain gage 112.2 is stressed in compression by the same loading from the load distributor 106, so as to enhance signal gain and to provide inherent temperature compensation. Alternately, the plurality of strain gages 112 may be located so that at least one strain gage 112 is stressed by loading from the load distributor 106, and at least one other strain gage 112 is elsewhere on the beam 100, but not stressed, so as to provide inherent temperature compensation. Referring to FIGS. 10 and 11, a system of four strain gages 112.2, 112.2, with two in tension and two in compression responsive to a same loading from the load distributor 106, can be interconnected and operated in a 4-arm Wheatstone Bridge 124 circuit configuration so as to enhance signal gain and to provide inherent temperature compensation.

Referring to FIG. 12, the electronic circuit 120 may also be adapted so that the strain gages 112.1 and 112.2 are arranged as two half-bridges 126.1, 126.2, each comprising a strain gage 112.1 in tension and a strain gage 112.2 in compression, wherein the respective signals at the respective signal junctions 128.1, 128.2 are connected to respective separate signal conditioners 130.1, 130.2, e.g. amplifiers 132.1, 132.2, in the circuitry 134 of the ASIC 121. A temperature sensor 136 for sensing the temperature of the substrate 118 and/or ASIC 121 is also operatively connected to the circuitry 134 of the ASIC 121. In operation, respective separate signals 138.1, 138.2 from each respective half-bridge 126.1, 126.2 are separately measured and compared by the ASIC 121. If the separate signals 138.1, 138.2 are sufficiently the same as one another, both are considered valid and are used to generate an output signal 140 representative of the strain in the beam 100, and consequently the magnitude of the second force 84 applied thereto. A signal from the temperature sensor 136 may be used to compensate the output signal 140 for the affect of temperature on either the half-bridges 126.1, 126.2 or the ASIC 121. Otherwise, if the separate signals 138.1, 138.2 are sufficiently different, a failure condition is indicated.

Referring to FIGS. 8 and 13, the deflector 72 is adapted to operatively engage the webbing 12 at a third location 74, wherein the third location 74 is between the first location 64 and the second location 66. The deflector 72 comprises a compliant element 80 such as a spring 80′ having an associated force-deflection characteristic. The deflection of the deflector 72 is responsive to a transverse load from the webbing 12. In the limit as the tensile load T is increased, the deflector 72 becomes sufficiently deflected that the webbing 12 becomes stretched straight between the first 64 and second 68 locations, and the transverse load from the deflector 72 to the webbing 12 reaches a limit. The spring 80′ could be any kind of spring element, either singular or plural, including but not limited to a cantilevered spring, a helical spring, a torsion spring, or a compliant material such as an elastomer or foam. In the embodiment illustrated in FIGS. 8 and 13, the spring 80′ is cantilevered from the first housing portion 92. The spring 80′ is also substantially flat; and comprises at least one opening 144 between an attachment location 146 and a location 148 to which a load is applied by the webbing 12. The at least one opening 144 provides for tuning the force-deflection characteristic of the deflector 72, particularly when using a commercially available thickness for the material of the associated spring 80′. The material of the spring 80′ may, for example, comprise spring steel, for example, full hardened type 301 stainless steel. The deflector 72 further comprises a load distributor 150 operatively connected to the spring 80′ at the location 148 relatively distal in relation to the associated attachment location 126, wherein the load distributor 150 transfers a load from the webbing 12 to the spring 80′. The load distributors 106, 150 of the sensor 86 and deflector 72 are sufficiently wide to span across the width of the webbing 12, and enable the substrate 118 of the sensor 86 and the spring 80′ of the deflector 72 to be narrower than the width of the webbing 12. Whereas FIG. 8 illustrates the deflector 72 attached proximate to an end of the first housing portion 92 that is proximate to the first location 64, the deflector 72 could alternately be attached proximate to the opposite end of the first housing portion 92, i.e. closer to the second location 66 than to the first location 64, so as to reduce the overall length of the housing 90.

The dimensions of the substrate 118 can be adapted to limit the maximum stress and strain therein when subjected to the maximum loading conditions. For example, for a substrate 118 having a yield strain of about 1400 to 1600 microstrain, the dimensions of a working example were adapted so that a maximum transverse loading of 24 lb to the webbing 12 by the deflector 72 at maximum deflection (with the webbing 12 stretched straight between the first 64 and second 66 locations) caused a strain of 1000 microstrain in the substrate 118. The associated stress in the substrate 118 and deflector 72 were each less than 60% of the associated yield stresses so as to provide a practically unlimited fatigue life in both components. For about a 20 pound seat belt load, the deflector 72 caused a transverse loading of about 8 to 9 pounds, causing a strain of about 500 microstrain in the substrate 118.

The guide surface 88, the deflector 72 and the sensor 86 are arranged so that the third location 74 is displaced by a relative displacement x in the first direction 68 relative to a line 78 between the first location 64 and the second location 66 when there is substantially no tensile load T in the webbing 12, wherein the relative displacement x is responsive to the deflection of the deflector 72 responsive to the tensile load T in the webbing 12.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

We claim:

1. An apparatus for measuring a tensile load in a flexible element, comprising:
a. a housing;
b. a guide surface either operatively coupled to or a part of said housing, wherein said guide surface is adapted to support the flexible element at a first location so as to substantially prevent transverse displacement of the flexible element in a first direction relative to said housing at said first location;
c. a deflector comprising a spring operatively coupled to said housing, wherein said deflector is adapted to operatively engage the flexible element at one of a second location and a third location;
d. a sensor operatively coupled to said housing, wherein
i. said sensor is adapted to operatively engage the flexible element at another of said second location and said third location;
ii. said third location is between said first location and said second location;
iii. the operative engagement of said sensor with the flexible element acts to resist transverse displacement thereof in said first direction;
iv. said guide surface, said deflector and said sensor are arranged so that said third location is displaced by a relative displacement in said first direction relative to a line between said first location and said second location when there is substantially no tensile load in the flexible element;
v. a deflection of said deflector is responsive to said tensile load in the flexible element along the flexible element;
vi. said relative displacement is responsive to said deflection of said deflector; and
vii. said sensor is responsive to a component of force from the flexible element in said first direction.

2. An apparatus for measuring a tensile load in a flexible element as recited in claim 1, wherein said spring is cantilevered from said housing.

3. An apparatus for measuring a tensile load in a flexible element as recited in claim 2, wherein said spring is substantially flat.

4. An apparatus for measuring a tensile load in a flexible element as recited in claim 3, wherein said spring comprises at least one opening between an attachment location and a location to which a load is applied to said spring by said flexible element.

5. An apparatus for measuring a tensile load in a flexible element as recited in claim 1, further comprising a first load distributor operatively connected to said spring at a location relatively distal in relation to a location where said spring is operatively coupled to said housing, wherein said first load distributor transfers a load from said flexible element to said spring.

6. An apparatus for measuring a tensile load in a flexible element as recited in claim 1, wherein said sensor comprises:
a beam supported by said housing at at least one support location; and
a second load distributor operatively coupled to said beam at a location on said beam that is displaced from said at least one support location, wherein said second load distributor transfers a load from said flexible element to said beam.

7. An apparatus for measuring a tensile load in a flexible element as recited in claim 6, wherein said beam is supported at at least two support locations by said housing.

8. An apparatus for measuring a tensile load in a flexible element as recited in claim 7, wherein said beam is transversely free at said two support locations.

9. An apparatus for measuring a tensile load in a flexible element as recited in claim 6, wherein said second load distributor is substantially centered between said two support locations.

10. An apparatus for measuring a tensile load in a flexible element as recited in claim 6, wherein said sensor further comprises at least one strain gage on said beam.

11. An apparatus for measuring a tensile load in a flexible element as recited in claim 10, wherein said at least one strain gage is located on a surface of said beam opposite to a surface upon to which said second load distributor is operatively coupled.

12. An apparatus for measuring a tensile load in a flexible element as recited in claim 10, wherein said at least one strain gage comprises at least one cermet material.

13. An apparatus for measuring a tensile load in a flexible element as recited in claim 12, wherein said at least one strain gage is formed by printing or screening said at least one cermet material on said beam and then exposing said beam to an elevated temperature.

14. An apparatus for measuring a tensile load in a flexible element as recited in claim 10, wherein said sensor further comprises an electronic circuit operatively connected to said at least one strain gage, and said electronic circuit is operatively connected to a surface on an extension of said beam.

15. An apparatus for measuring a tensile load in a flexible element as recited in claim 6, wherein said sensor further comprises a plurality of strain gages on said beam.

16. An apparatus for measuring a tensile load in a flexible element as recited in claim 15, wherein said plurality of strain gages are mounted on a common surface of said beam.

17. An apparatus for measuring a tensile load in a flexible element as recited in claim 16, wherein at least one of said plurality of strain gages is located proximate to a location on said common surface that undergoes tension when said beam is loaded by a load from said second load distributor, and at least one of said plurality of strain gages is located proximate to a location on said common surface that undergoes compression when said beam is loaded by a load from said second load distributor.

18. An apparatus for measuring a tensile load in a flexible element as recited in claim 1, wherein said housing comprises a pin that operatively engages the flexible element so as to restrain translation of said housing along the flexible element.

19. A method of measuring a tensile load in a flexible element, comprising:
a. supporting the flexible element at a first location so as to resist transverse displacement thereof in a first direction relative to a datum;
b. supporting the flexible element at a second location so as to resist transverse displacement thereof in said first direction relative to said datum wherein said operation of supporting the flexible element at one of said first location and said second location is provided by a means that is substantially rigid relative to said datum;
c. transversely displacing the flexible element at a third location in said first direction wherein said third location is between said first location and said second location and a relative transverse displacement of the flexible element at said third location in said first direction relative to a line between said first location and said second location is responsive to a tensile load in the flexible element when said tensile load is applied to the flexible element so as to be directed along said flexible element;
d. applying a first force having a vector component in said first direction to the flexible element wherein said first force is applied by at least one compliant element either at or operatively coupled to one of said first location, said second location, and said third location, wherein said at least one force is responsive to said relative transverse displacement of the flexible element; and
e. measuring a second force at a location either at or operatively coupled to a location that is different from said one of said first location, said second location, and said third location wherein said second force is responsive to said tensile load in the flexible element.

20. A method of measuring a tensile load in a flexible element as recited in claim 19, wherein said at least one compliant element is adapted so that as said tensile load in the flexible element is increased, a deflection of said compliant element approaches a limit and the flexible element approaches a shape that is straight between said first and second locations.
